(19) United States
(12) Patent Application Publication
(10) Pub. No.: US 2016/0085241 A1
(43) Pub. Date: Mar. 24, 2016

(54) FLOW DETECTION DEVICE AND NUMERICAL MODELING METHOD

(71) Applicant: Chin-Tsung LEE, New Taipei City (TW)

(72) Inventor: Chin-Tsung LEE, New Taipei City (TW)

(21) Appl. No.: 14/490,222

(22) Filed: Sep. 18, 2014

(51) Int. Cl. G05D 7/06; G05B 17/02; G01F 1/05

(52) U.S. Cl. CPC G05D 7/0635; G01F 1/05; G05B 17/02

(57) ABSTRACT

The present invention provides a flow detection device and numerical modeling method, the device for controlling the gas flow in the pipeline. The flow detection device includes a measurement pipe, valve control module, flow detection module and a processing module. The processing module can be detected by flow detection data a numerical model of the flow characteristics curve fitting. The processing module for feedback signal, it's for control the valve structure of open degree, with precise control of the flow.

### BACKGROUND OF THE INVENTION

1. Field of the Invention

The present discloses a flow detection device and numerical modeling method, in particular applicable to control gas flow in a pipeline and to establish numerical modeling based on data measurement and feedback a control signal to control an opening degree of a valve device so as to control the flow in the pipeline precisely.

2. Description of the Related Art

Fluids in a piping system may be crushed due to the arrangement of pipe assemblies (valve, curved pipe, manifold pipe, varied diameter pipe, filter . . . etc.) such that distribution of the flow velocity and flow rate in the pipe becomes unstable. However, there are no any apparatuses that enable to directly measure flow rate, and it can merely refer to the result by flow rate detection devices. Owing to the difference of usage environment, the simulated result from laboratory or inferred formula are not able to be applied in the scene, resulting that the flow rate control in the piping system being kept in open-loop control environment; as a result, it is unable to effectively promote the control precision thereof.

Moreover, when the piping fluid is flowing through a valve structure, the rear fluid causes different levels of turbulent flow as the opening angle variation of the valve structure, such that the signal precision is decreased due to the increase of measurement error.

According to the preceding description, the inventor of the present invention is therefore designs a flow detection device and numerical modeling method which aims to improve the current technique so as to increase the industrial practicality.

### SUMMARY OF THE INVENTION

In view of the aforementioned technical problems of the prior art, purpose of the present invention is to provide a flow detection device and a numerical modeling method which measures the practical gas flowing condition by directly connecting the measurement pipe within the piping system, and to send the measurement signal arranged in different positions back the processing module to establish a numerical modeling, so that a corresponding control signal based on the set flow can be sent to adjust the opening degree of the valve structure.

In view of the aforementioned technical problems of the prior art, purpose of the present invention is to provide a flow detection device and a numerical modeling method, the applied numerical modeling is able to be corrected according to practical detection signals so as to provide stable flow and satisfy with the demand of flow and achieve purpose of feedback control.

According to the aforementioned purpose, the present invention is to provide a flow detection device which is adapted to control a gas flow in a pipeline. The flow detection device may comprise a measurement pipe, a valve control module, a flow detection module and a processing module. The measurement pipe may be disposed at one side of the pipeline.

The valve control module may be disposed in the measurement pipe and may comprise a valve structure and a valve actuating unit, the valve control module may adjust an opening degree of the valve structure by the valve actuating unit.

The flow detection device may comprise a plurality of detection units, and the plurality of detection units respectively may be disposed at two sides of the measurement pipe and transmitting a plurality of corresponding detection signals. The processing module may receive the plurality of detection signals and establish a flow characteristics curve fitting according to the plurality of detection signals, and determine to send a control signal to the valve control module based on the flow characteristics curve fitting to control the opening degree of the valve structure so as to adjust gas throughput of the measurement pipe.

Preferably, the measurement pipe may further comprise a changeover connector contributing to assembly when pipe diameter of the measurement pipe may be different from pipe diameter of the pipeline.

Preferably, the valve structure may further comprise a surface coating increasing corrosion resistance of the valve structure.

Preferably, the flow detection device of the present invention may further comprise a fairing module reducing turbulent flow.

Preferably, the flow characteristics curve fitting may calculate a fitting by a data fitting algorithm.

Preferably, the data fitting algorithm may comprise least squares method, conjugate gradient method or regression analysis.

Preferably, the plurality of detection signals may comprise wind velocity, wind pressure, wind temperature or combination thereof.

According to the aforementioned purpose, the present invention further provides a flow detection numerical modeling method which may comprise the following steps:

a) disposing a plurality of detection units at two sides of a measurement pipe;

b) adjusting an opening degree of a valve structure by a valve actuating unit orderly;

c) measuring a plurality of corresponding detection signals by the plurality of detection units;

d) returning the plurality of detection units to a processing module, and establishing a flow characteristics curve fitting by a data fitting algorithm; and

e) determining to send a control signal to control the opening degree of the valve structure according to the flow characteristics curve fitting so as to adjust gas throughput of the measurement pipe.

Preferably, the data fitting algorithm may comprise least squares method, conjugate gradient method or regression analysis.

Preferably, the plurality of detection signals may comprise wind velocity, wind pressure, wind temperature or combination thereof.

The primary purpose of the present invention is to provide a flow detection device and numerical modeling method which may have one or more following advantages:

1. Numerical modeling: using practical detected detection signals to establish a corresponding numerical modeling matching up various environments and further correct the modeling parameter obtained by inferred theory so as to promote the precision.

2. Instantly feedback: using a numerical modeling to establish the flow characteristics curve fitting to send a control signal to a valve control module to control an opening degree of a valve structure so as to adjust gas throughput of a measurement pipe.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

Hereinafter, embodiments of the present invention will be described in detail with reference to the accompanying drawings so that those skilled in the art to which the present invention pertains can realize the present invention, wherein:

FIG. 1 is a block diagram of a flow detection device of the resent invention.

FIG. 2 is a schematic diagram of an embodiment of a flow detection device of the present invention.

FIG. 3 is a flow diagram of steps of a flow detection numerical modeling method of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The exemplary embodiments of the present invention will be understood more fully from the detailed description given below and from the accompanying drawings of various embodiments of the invention, which, however, should not be taken to limit the invention to the specific embodiments, but are for explanation and understanding only.

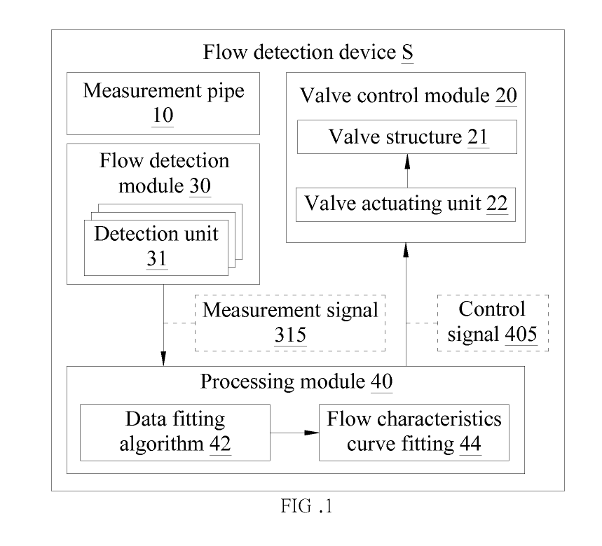

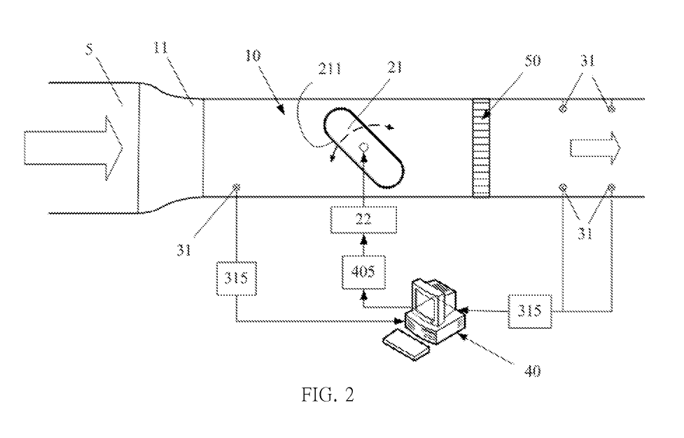

Please refer to FIG. 1 along with FIG. 2. FIG. 1 is a block diagram of a flow detection device of the resent invention, and FIG. 2 is a schematic diagram of an embodiment of a flow detection device of the present invention. It can be seen from the FIGS. that a flow detection device S is to control gas flow in a pipeline 5, and to further adjust the flow in the pipeline 5 to benefit the follow-up application. The flow detection device S comprises a measurement pipe 10, a valve control module 20, a flow detection module 30 and a processing module 40.

The measurement pipe 10 is disposed at one side of the pipeline 5, and when the pipe diameters of the pipeline 5 and the measurement pipe 10 are different from each other, a changeover connector 11 is added to contribute to assembly.

The valve control module 20 is disposed in the measurement pipe 10, and the valve control module 20 comprises a valve structure 21 and an actuating unit 22. The valve control module 20 adjusts an opening degree of the valve structure 21 by the actuating unit 22. In applicability, the valve structure is common butterfly valve or the other kinds of valves; the adequate valve structure 21 is selected under the demands for diameter and strength of pipe, and outer surface of the valve structure 21 is coated a surface coating 211 which increases corrosion resistance of the valve structure 21 to prevent corrosive gases in the pipeline 5 damaging the valve structure 21, resulting that the structure is destroyed or the device malfunctions.

The flow detection module 30 comprises a plurality of detection units 31, and the plurality of detection units 31 are respectively disposed at two sides of the measurement pipe and transmit a plurality of corresponding detection signals 315. The detection units 31 include a plug-in flow measurescope, ultrasonic flow measurescope, differential pressure flow measurescope and so on. The detected detection signals comprise a wind velocity, a wind pressure, wind temperature or the combination thereof. The measurement when the detection signal 315 changes into the wind temperature exceeds for the set threshold, the valve control module 20 transmits the emergency signal to close the valve structure 21, and transmits a warning signal to alert the operator and for processing.

When a part of the plurality of detection units 31, which is disposed at front end of the valve control module 20 is the flow field signal in the measurement pipe 10, the related signals are relative stable as not being affected by the turbulent flow; and when the remaining detection units 31 are disposed at rear end of the valve control module 20, the detected signal is unstable due to the influence of the turbulent flow, boundary current effect and so on. In order to resolve the technical problems, the present invention therefore provides the following solutions.

Firstly, it can correct and accordingly analyze the plurality of detection units 31 disposed at rear end of the valve control module 20 via the detection signals 315 of different positions by using arrangements of interval type, wrap-around or combination thereof so as to reduce the measurement error of the detection signals 315.

Secondly, it can add a fairing module 50 at rear end of the valve control module 20 to reduce turbulent flow caused by the fluid in the measurement pipe 10 being blocked as the deflection of the valve structure 21 so as to promote the precision of the detection signals 315.

Thirdly, by using the actuating unit 22 to slowly adjust the opening degree of the valve structure 21, it can avoid the unstable detection signals 315 caused by the rapid change of flowing area.

The processing module 40 is to receive the plurality of detection signals 315 disposed at two sides of the measurement pipe 10, and to establish a numerical modeling of the flow characteristics curve fitting 44 by data fitting algorithm 42 such as least squares method, conjugate gradient method or regression analysis and so on. When a user sets a predetermined flow, the flow detection device S uses the flow characteristics curve fitting 44 to send the corresponding control signal 405 to the valve control module 20 to control the opening degree of the valve structure 21 so as to adjust gas throughput of the measurement pipe 10. In addition, it can use the detection signals 315 to feedback the opening degree of the valve structure 21 so as to provide stable flow and satisfy with the set flow demand to achieve the purpose of feedback control.

Furthermore, the user establishes several common or inferred flow field modelings in the processing module 40, and selects adequate matched numerical modeling based on practical application, and accordingly corrects the flow characteristics curve fitting 44 of the numerical modeling by the plurality of received detection signals 315.

If the built-in numerical modeling is unable to match up the usage environment, it has to control the valve actuating unit 22 to orderly adjust the opening degree of the valve structure 21 based on the measurement solution and capture the plurality of corresponding detection signals 315 of the valve structure 21 in different levels by the flow detection module 30 and return to the processing module 40 to establish the corresponding flow characteristics curve fitting 44 by the data fitting algorithm 42.

When the establishment or correction of the numerical modeling of the flow characteristics curve fitting 44 is completed, the user inputs the desired flow demand to the processing module 40, and the processing module 40 calculates the desired flow demand in modeling of the flow characteristics curve fitting 44 to obtain the necessary opening degree of the valve structure 21 and sends the corresponding control signal 405 to the valve control module 20 to adjust the opening degree of the valve structure 21, and the plurality of measured detection signals 315 are thereby used to feedback the opening degree of the valve structure 21.

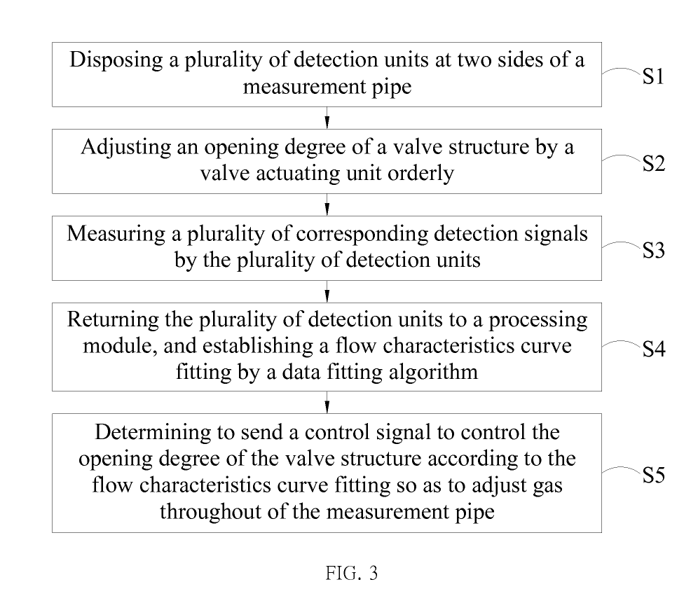

Please refer to FIG. 3 which is a flow diagram of steps of flow detection numerical modeling method of the present invention. In step S1, the plurality of detection units 31 are disposed at two sides of a measurement pipe 10. The plurality of detection units 31 are adequately disposed in relative position of the measurement pipe 10 based in the practical environment and need. In step S2, the opening degree of the valve structure 21 is adjusted by a valve actuating unit 22 orderly, and in step S3, the plurality of corresponding detection signals 315 measured by the plurality of detection units 31. In implementation, the action velocity of the valve actuating unit 22 can be controlled to further increase the measurement data quantity of the detection signals 35.

In step S4, the plurality of detection units 315 are returned to the processing module 40, and the flow characteristics curve fitting 44 is established by a data fitting algorithm 42, wherein the flow characteristics curve fitting 44 establishes the corresponding numerical modeling by the data fitting algorithm 42 such as least squares method, conjugate gradient method or regression analysis and so on. Subsequently, in step S5, it is determined to send the control signal 405 to control the opening degree of the valve structure 21 according to the flow characteristics curve fitting 44 so as to adjust gas throughput of the measurement pipe 10, wherein it can use the detection signals 315 to feedback the opening degree of the valve structure 21 so that the stable flow is provided and the set flow demand is satisfied.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A flow detection device adapted to control a gas flow in a pipeline, comprising:
a measurement pipe disposed at one side of the pipeline;
a valve control module disposed in the measurement pipe comprising a valve structure and a valve actuating unit, and configured for adjusting an opening degree of the valve structure by the valve actuating unit;
a flow detection module comprising a plurality of detection units, and the plurality of detection units respectively disposed at two sides of the measurement pipe and transmitting a plurality of corresponding detection signals; and
a processing module receiving the plurality of detection signals and establishing a flow characteristics curve fitting according to the plurality of detection signals, and determining to send a control signal to the valve control module based on the flow characteristics curve fitting to control the opening degree of the valve structure so as to adjust gas throughput of the measurement pipe.

2. The flow detection device of claim 1, wherein the measurement pipe further comprises a changeover connector contributing to assembly when pipe diameter of the measurement pipe is different from pipe diameter of the pipeline.

3. The flow detection device of claim 1, wherein the valve structure further comprises a surface coating increasing corrosion resistance of the valve structure.

4. The flow detection device of claim 1, further comprising a fairing module reducing turbulent flow.

5. The flow detection device of claim 1, wherein the flow characteristics curve fitting calculates a fitting by a data fitting algorithm.

6. The flow detection device of claim 5, wherein the data fitting algorithm comprises least squares method, a conjugate gradient method or a regression analysis.

7. The flow detection device of claim 1, wherein the plurality of detection signals comprises wind velocity, wind pressure, wind temperature or combination thereof.

8. A flow detection numerical modeling method, comprising:
a) disposing a plurality of detection units at two sides of a measurement pipe;
b) adjusting an opening degree of a valve structure by a valve actuating unit orderly;
c) measuring a plurality of corresponding detection signals by the plurality of detection units;
d) returning the plurality of detection units to a processing module, and establishing a flow characteristics curve fitting by a data fitting algorithm; and
e) determining to send a control signal to control the opening degree of the valve structure according to the flow characteristics curve fitting so as to adjust gas throughput of the measurement pipe.

9. The flow detection numerical modeling method of claim 8, wherein the data fitting algorithm comprises least squares method, a conjugate gradient method or a regression analysis.

10. The flow detection numerical modeling method of claim 8, wherein the plurality of detection signals comprises wind velocity, wind pressure, wind temperature or combination thereof.
